(19) United States
(12) Patent Application Publication
(10) Pub. No.: US 2013/0311354 A1
(43) Pub. Date: Nov. 21, 2013

(54) PRODUCT LEASING SYSTEM AND METHOD

(71) Applicants: Mark Williams, Norwalk, CT (US); Susan Grafton, Edina, MN (US); Brent Pickett, Edina, MN (US)

(72) Inventors: Mark Williams, Norwalk, CT (US); Susan Grafton, Edina, MN (US); Brent Pickett, Edina, MN (US)

(73) Assignee: BBY SOLUTIONS, INC., Richfield, MN (US)

(21) Appl. No.: 13/473,078

(22) Filed: May 16, 2012

(51) Int. Cl. G06Q 30/06; G06Q 40/02

(52) U.S. Cl. 705/38

(57) ABSTRACT

A computerized system and method for leasing products includes defining a lease of an item, for example, an electronics product. The system includes a computer database that tracks product and service items, the cost for leasing of the items, and the cost to provide updates for product items. The bundled products and services are leased at a predetermined rate calculated using the database of the computerized system. At the option of the lessee, each product may be upgraded to a newer version of the original product in the same product class. The rate does not change over the course of the lease term. In the disclosed embodiment, the upgrade product is not identified in the lease because it is not available for sale or lease at the start of the lease term.

### FIELD OF THE INVENTION

The present application relates to the field of leasing products. More particularly, the described embodiments relate to a system and method for leasing bundled technology products and services. A lessee may upgrade one or more of the technology products or services before the lease term expires. The lease payment does not change during the lease term.

### BACKGROUND

Electronic goods are in high demand but are often very costly. In some product categories, new product versions may be released in very short intervals. For example, an electronics company may produce a new version of a single product every year. The new product typically has improved features such as a larger memory, faster processing speed, an upgraded operating system, or better graphic resolution. Consumers would like to have the latest electronics products, but the cost of replacing an old product with a new product every year is very high.

In a conventional lease, the lessee chooses a single product to lease, a lease duration, a lease start date, and a lease end date. The lessee pays the same payment price throughout the duration of the lease, but once the lease agreement is signed the lessee is locked in to keeping the single product throughout the lease term. Because of the speed at which electronics technology improves, this arrangement is undesirable for a consumer who wishes to lease electronics products unless the lease term is so short as to be increase the payment price to an unacceptable level.

### SUMMARY

One embodiment of the present invention provides a product leasing system and method in which a lessee may upgrade a leased product to a newer model of the product within the lease term. The leased products in one embodiment include electronics products such as notebook and tablet computers, mobile phones, smartphones, gaming consoles, televisions, multimedia players, digital cameras and camcorders, and other consumer electronics products. The leased products could also include items for the home such as furniture, appliances, and other such goods. In one aspect of the invention, a lease includes one or more products, along with services associated with the products. As part of the lease agreement, the lessee may, at the lessee's option, upgrade the one or more leased products to newer models of those products during the lease term without altering the lease payment.

In the preferred embodiment the lease rate charged by the lessor does not change during the lease term. The lessor calculates the lease price based on one or more of the following inputs: the price of the product to lease, the lease duration, the lease term including the lease start date and lease end date, the projected residual value of the leased product, the projected price of an upgrade product, the residual value of the upgrade product, and the cost to provide selected services for the products.

The system for leasing products may include a plurality of databases connected to a computer. A lessor may use the computer to track leases for multiple lessees. Lease information is stored in the databases, and the lease information may be queried to determine whether a leased product is eligible to be upgraded. A lessee that chooses to lease more than one product in a single lease agreement may request to upgrade a first leased product at a first date, and request to upgrade a second leased product at a different date that is before or after the date of the request to upgrade the first product. The requests may also be made on the same date.

### BRIEF DESCRIPTION OF THE DRAWINGS

FIG. 1 is a schematic diagram of a system for leasing products.

FIG. 2 is a schematic diagram representing information stored in a computer system used to calculate a lease price and to track lease information.

FIG. 3 is a flow chart demonstrating a leasing method.

FIG. 4 is a flow chart demonstrating a method for calculating the payment for a lease.

FIG. 5 is a flow chart demonstrating a method for leasing two products.

FIG. 6 is a flow chart demonstrating a method for including a service in a lease agreement.

### DETAILED DESCRIPTION

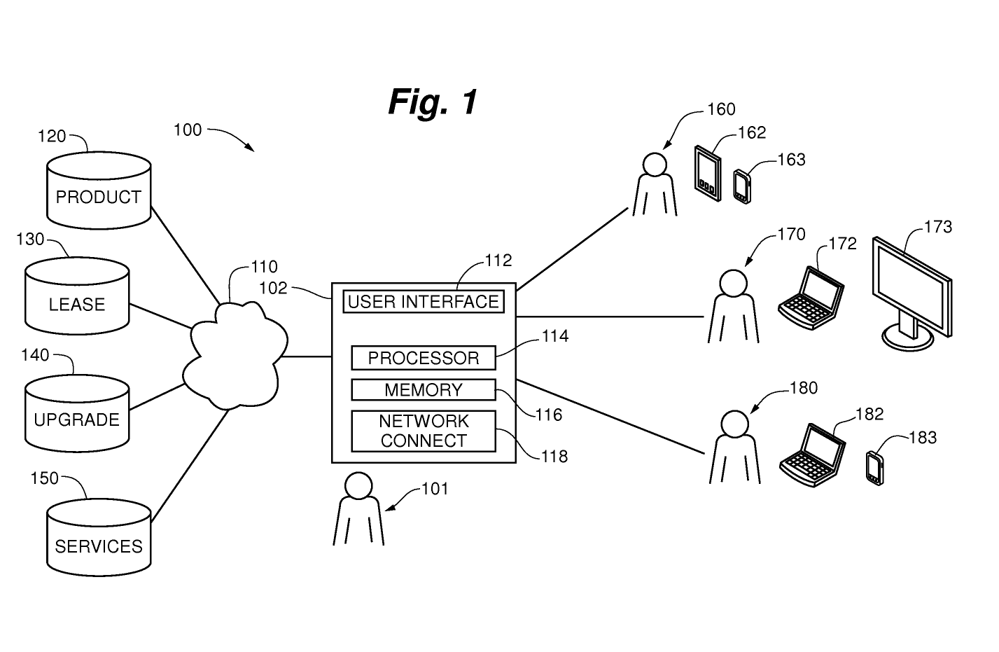

FIG. 1 shows a leasing system 100 comprising a computer 102 connected by a network 110 to one or more databases. Computer 102 includes a processor 114, a memory 116, a network interface 118, and a user interface 112 for entering information into databases and administering the databases. Computer 102 may be a workstation, a point of sale register, a notebook computer, a desktop computer, a tablet computer, a mobile data device, or other computing device. User interface 112 on computer 102 allows access to remote databases. User interface 112 may display database records, may allow database queries to be sent to the databases, may display query results, and may allow data editing or data entry into the databases. The databases of system 100 may include a product database 120 containing information about products available to lease; a lease database 130 containing information about executed lease agreements; an upgrade database 140 containing information about upgrade products associated with products in product database 120; and a services database 150 containing information about services related to the products in product database 120. Computer 102 may be operated by a leasing representative 101 who may be a retail salesperson. Representative 101 interacts with computer 102 through user interface 112. The representative 101 assists customers in choosing products and services and administers the process of entering the lease agreements into the database 130.

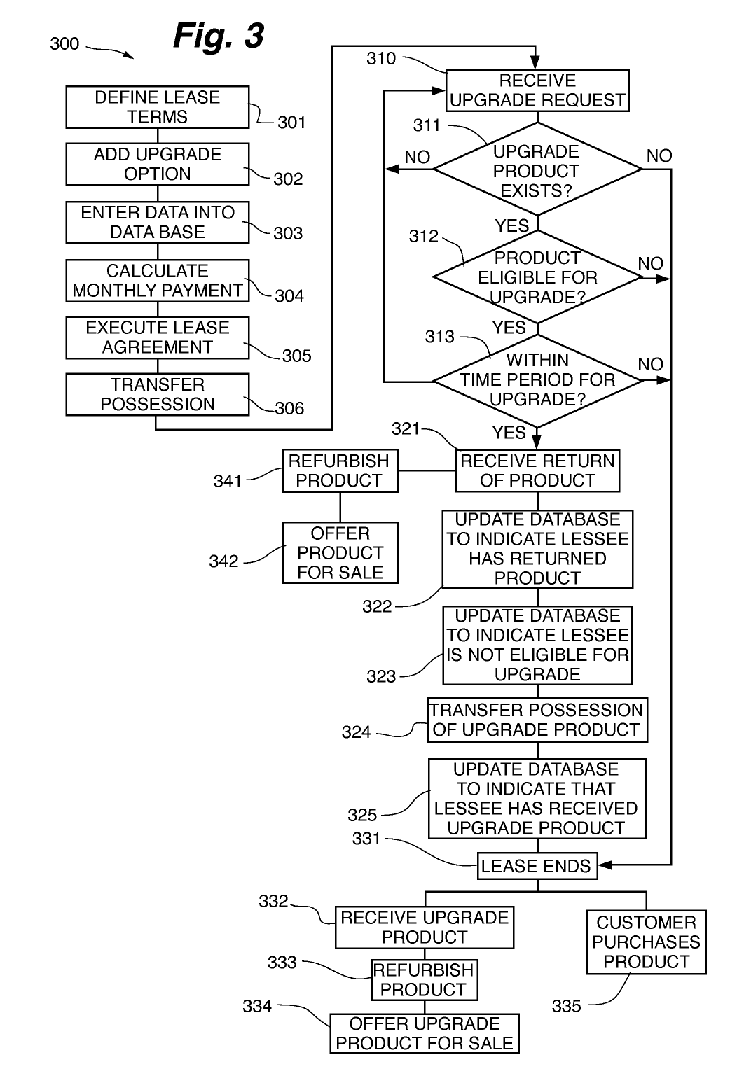

As shown in FIG. 1, the system includes one or more lessees, such as lessees 160, 170, and 180. In the exemplary embodiment of FIG. 1, lessee 160 leases a tablet computer 162, and a mobile phone 163. In this exemplary embodiment, lessee 160 may also receive a service associated with one or more of devices 162, 163, such as a cable television or Internet service, a mobile phone plan, or a mobile data plan. As will be discussed in relation to FIGS. 3-6, the lessee 160 has a lease that incorporates both the leased products and the services associated with the products. In this exemplary embodiment, devices 162, 163 are original leased products that have not been upgraded.

In the exemplary embodiment of FIG. 1, lessee 170 leases notebook computer 172 and television 173. Lessee 170 may also lease services associated with devices 172, 173, such as cable television and internet services, as well as installation services such as home theater installation and wireless home networking setup. In the exemplary embodiment, television 173 is an upgrade product that is a newer version of an original leased product, while notebook computer 172 is an original product that has not been upgraded. Lessee 180 leases notebook computer 182 and mobile phone 183. In the exemplary embodiment, the lease for lessee 180 may additionally include an extended warranty service and a data backup service for devices 182, 183. In this exemplary embodiment both notebook computer 182 and mobile phone 183 may be upgrade products that were upgraded from original products at lessee 180's request.

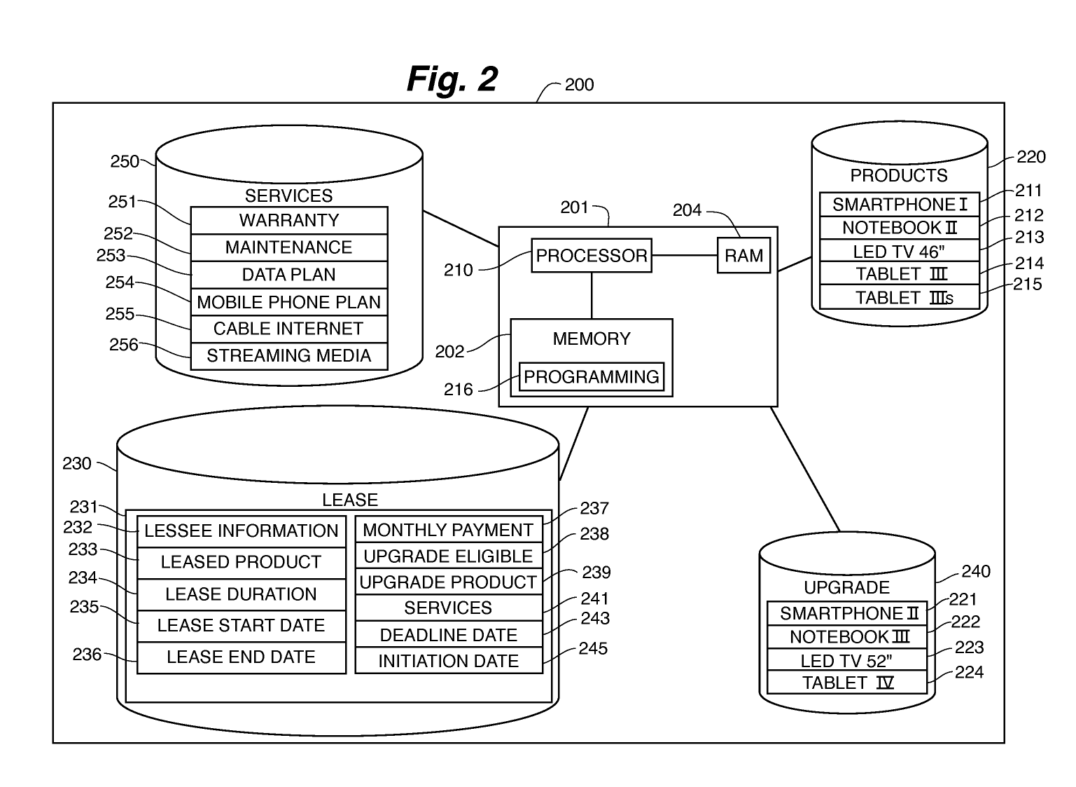

FIG. 2 shows a processing system 200 comprising a group of databases that are accessible by a computerized system 201 for use in system 100 of FIG. 1. The computerized system 201 contains a processor 210 for operating computer programming 216, the programming 216 being stored in non-transitory computer memory 212. The computerized system 201 recalls the programming 216 from memory 212 into RAM 214 for operation on the processor 210. The programming instructions 216 access the databases of FIG. 2 for the purpose of performing the computer-implemented methods described below in connection with FIGS. 3-6.

The databases include a products database 220, a lease database 230, an upgrade database 240, and a services database 250. Each database can be implemented as a relational database table containing the data fields described below. Alternatively, each of the databases in FIG. 2 could be implemented using a variety of related database tables. It is also possible to implement the databases as objects in an object oriented database. The distinction made between the databases in FIG. 2 and the following description are made for ease in understanding the data maintained and manipulated by the computerized system 201. It is well within the scope of the present invention to combine each of the databases together into a single database structure. Furthermore, it is possible to combine multiple databases together, either within a single table or other database structure, or through the use of database relationships, associations, or object class definitions.

Products database 220 contains a listing of products available to lease, as well as information associated with each product. Such information may include retail price, product description, a SKU or other identifier, a product category, and other information relevant to each product. In the preferred embodiment the product categories may include home and electronics product categories, such as notebook and tablet computers, mobile phones, smartphones, gaming consoles, televisions, appliances, furniture, multimedia players, digital cameras and camcorders, and other consumer electronics products. In the exemplary embodiment of FIG. 2, products database contains information for devices 211, 212, 213, and 214. It will be understood that products database 220 is capable of storing product information for hundreds or even thousands of individual products.

Lease database 230 of FIG. 2 contains a plurality of lease information records 231. Each lease information record 231 contains one or more data fields containing information for a single executed lease agreement. In the preferred embodiment, each lessee with a lease agreement has a corresponding lease information record 231. Data fields in the lease information record 231 may include lessee information, comprising personally identifying lessee information 232, such as lessee name and address. The lease information record 231 may be identified by a lease identifier, which may be a unique identifier assigned to the lease agreement for which the upgrade is requested. The lease identifier could alternately be lessee information such as lessee name, address, social security number, driver's license number, credit card number, or other identifier that identifies a lease information record 231 associated with a lessee. Leased product record 233 contains a list of one or more products leased by the lessee at the beginning of the lease term. The leased product information 233 refers to the original product that the lessee receives. The original product is specifically identified in a lease agreement when the lease is signed.

Other information in the lease information record 231 includes lease duration 234, for example, 36 months. Lease start date 235 and lease end date 236 indicate the time period during which the lease agreement is in force, for example, Jan. 1, 2012 through Dec. 31, 2014.

Services 241 may include services associated with the leased product 233, such as cable television and internet plans, mobile phone plans, data plans, warranty services, maintenance services, etc. The services 241 are specifically named in the lease agreement and are bundled with the leased products for a single lease payment that does not change during the lease term.

Upgrade eligibility field 238 indicates whether the lessee is eligible to upgrade the leased product 232 to a newer version of the product. The upgrade eligibility 238 is an option that is made available to a lessee. The resulting lease is an “upgradable product lease,” in that the lease allows the lessee the option of upgrading the original leased product to an upgrade product once during the lease term. The upgrade eligibility is considered when the lessor calculates the lease payment in the lease agreement.

Lease payment field 237 in FIG. 2 stores the periodic lease payment that the lessee pays. The periodic lease payment may, for example, be paid monthly. The lease price may also be paid bimonthly, quarterly, yearly, or another agreed-upon payment period. The lease price may be calculated based on a number of different factors, including, but not limited to, the leased product category, the lease term, the lease duration, the option to upgrade, the leased product price, the leased product residual value, a projected price of the upgrade product, the projected residual value of the upgrade product at the end of the lease term, and an interest rate associated with the lessee.

If the lessee has upgraded the original product, upgrade product field 239 stores information indicating the upgrade product. In one embodiment, upgrade product field 239 is not filled until the lessee successfully upgrades the original product to an upgrade product. Although it is assumed that a new version (i.e., upgrade product) of the leased product will be released after the lease start date, in many instances the upgrade product has not been announced, and there is no known release date for the new version of the original leased product. Given the nature of the electronics industry, it is reasonable to believe that a newer version of certain types of electronics products will be released in predictable intervals. The product categories most likely to have available upgrades are tablet and notebook computers, mobile phones, wireless networking equipment, televisions, digital cameras and camcorders, multimedia players, and other such electronics products that take advantage of rapidly improving technology.

The data field for upgrade deadline date 243 contains the last date on which the lease record 231 allows a lessee to request a product upgrade. In one embodiment, the upgrade deadline date 243 is 90 days prior to the lease end date 236. This data field can be a field that is calculated by subtracting a known number of days (such as 90 days) from the lease end date field 236. Notably, the requirement that the lessee make the upgrade request a set number of days before the lease end date is necessary because the depreciation of an upgrade product is very steep in the first days of use. For example, the cost and inconvenience of providing an upgrade product and receiving the upgrade product back in fewer than 90 days is typically not financially advantageous to the lessor. For the same reason, the lease database records 231 may also include an upgrade initiation date 245. The initiation date 245 may be defined as a set number of days (such as 90 days) after the lease start date 235, and defines the earliest date on which the lessor will grant an upgrade request.

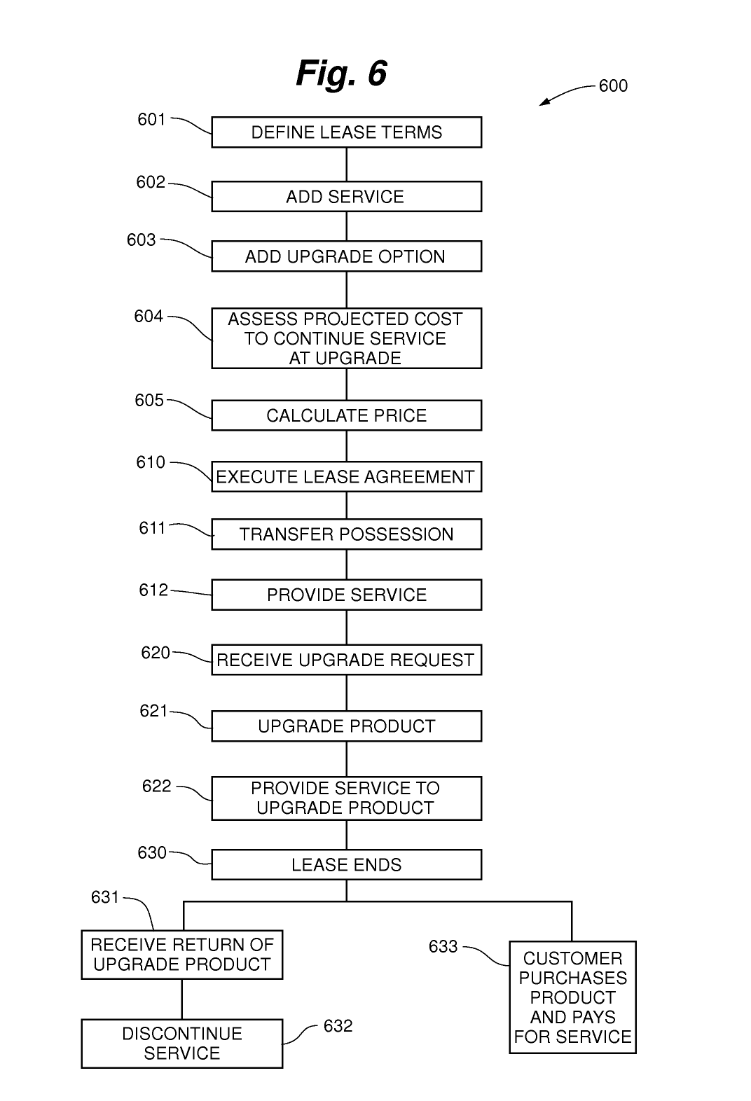

The services database 250 of FIG. 2 contains available services that are associated with electronics products in products database 220 and upgrade product database 240. Services may include warranty 251, maintenance 252, or technical support services. Cellular data plans 253 and mobile phone calling plans 254 may be included. Cable television and Internet 255, DSL Internet, or subscription streaming media services 256 may also be among those in services database 250. In the preferred embodiment, each product in products database 220 has at least one service associated with the product. A method for including a service for a leased product in a lease agreement will be discussed further in relation to FIG. 6.

Upgrade database 240 of FIG. 2 contains information for products available to lease that are newer versions of products in products database 220. In the exemplary embodiment of FIG. 2, upgrade product 221 is a newer version of product 211, upgrade product 222 is a newer version of product 212, upgrade product 223 is a newer version of product 213, and upgrade product 224 is a newer version of products 214 and 215. In the preferred embodiment, each upgrade product is in the same product category as an original product. The product categories may include electronics products, such as notebook and tablet computers, mobile phones, smartphones, gaming consoles, televisions, multimedia players, digital cameras and camcorders, and other consumer electronics products.

A single product in product database 220 may have more than one associated upgrade product in the upgrade database 240. As an example, if an original leased product is a Smartphone 211, the product 211 may be upgraded to a Smartphone 221 that is released on a release date that is after the start date of the lease. (Presumably, if Smartphone 221 is released on or before the lease start date 235, the lessee would choose to lease Smartphone 221 as the original leased product, as it would be the newest version of the product.) The lessee may also choose to wait to upgrade to an even newer version of the Smartphone 211 if the lessee believes that a newer version of Smartphone 221 will be available before the upgrade deadline date 243. In one embodiment, the upgradeable product lease allows a lessee to upgrade an item only one time during the lease term. In these embodiments, the lessee must weigh the benefits of upgrading to a new product against the possibility of an even newer product being released at a later date.

In some cases a single upgrade product in the upgrade database 240 may be eligible as an upgrade product to more than one original leased product in the products database 220. Two or more similar products in the products database 220 may be given only one upgrade product option in the upgrade database 240, based on the availability of new versions of products. For example, Tablet Computer 214 and Tablet Computer 215 may be similar products by the same manufacturer, but have different features. If the manufacturer chooses to only produce one newer version that replaces both products 214, 215, Tablet Computers 214 and 215 may both be upgraded to the newer Tablet Computer 224.

The lessor will generally be responsible for choosing which products are eligible upgrade products for an original leased product. This choice can be made when a manufacturer announces a new product, or when the product is entered into a retailer's product database for the first time. The assignment of upgrade products to original leased products can be based on a variety of factors, as described below. The association between the original leased products and their eligible upgrade products can be created in the databases 220 and 240 through the use of key fields in one or both of the databases, or through the use of link tables that link the records in the two databases 220, 240.

Although upgrade database 240 is depicted as a separate database in FIG. 2 for purposes of illustration, it is within the scope of the present embodiment for the upgrade products 221, 222, 223, and 224 to be listed in product database 220. In this case, the associations in the database 220 between original leased products and their eligible upgrade products would be made by linking records within the single database 220, such as through key fields or link tables.

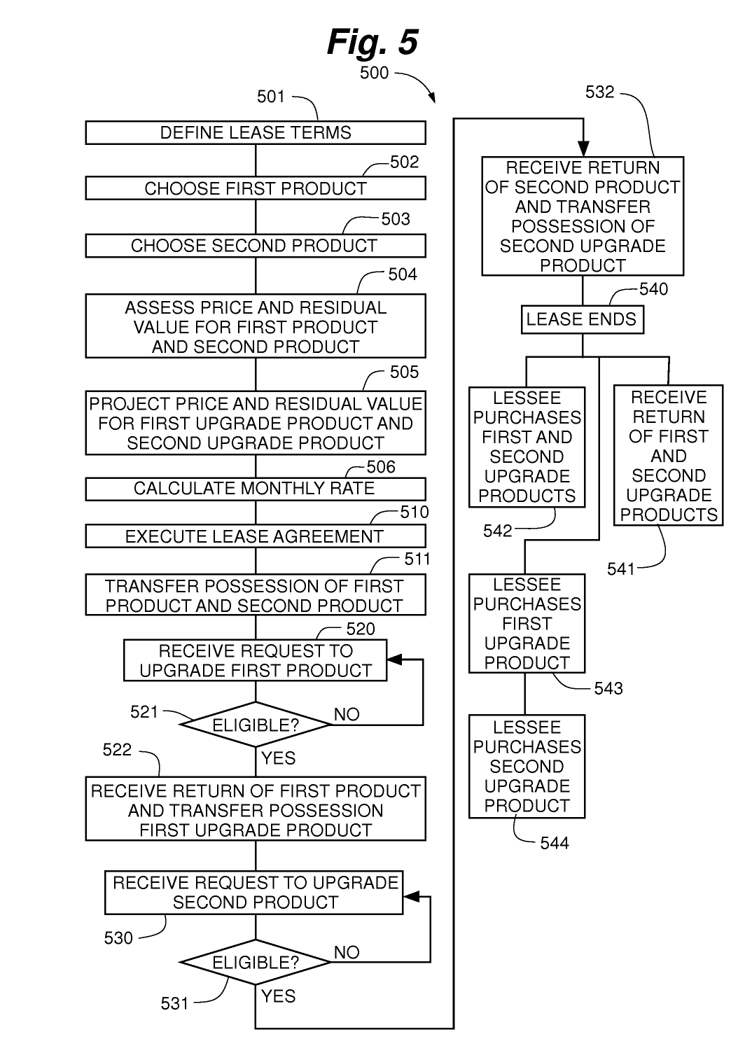

FIG. 3 details a method 300 for administering a lease agreement with an upgrade option using the computerized database system of FIG. 2. In step 301, lease terms and conditions are defined. This step may include gathering lessee information, choosing a lease term, choosing a lease duration, choosing one or more products to lease, determining an imputed rate for the lessee, and other details necessary for entering a lease agreement. Step 301 may include determining more than one product to lease, which will be described in further detail in relation to FIG. 5. Step 301 may include choosing one or more services to include in the lease, which will be described in relation to FIG. 6. In step 302 the lessee selects the product upgrade option. This upgradeable product lease option allows the lessee to upgrade the leased product to a newer version of the product during the lease term. In the preferred embodiment, the lessee is only allowed to exchange a leased product to a newer version of that product once during the lease, although it is contemplated that other embodiments would allow the upgraded product to also be replaced by a still newer product during the lease term. Step 303 includes entering lease information into a lease database, such as lease database 230 of FIG. 2. The data that is entered into the lease database 230 may be the data 232-245 as in FIG. 2.

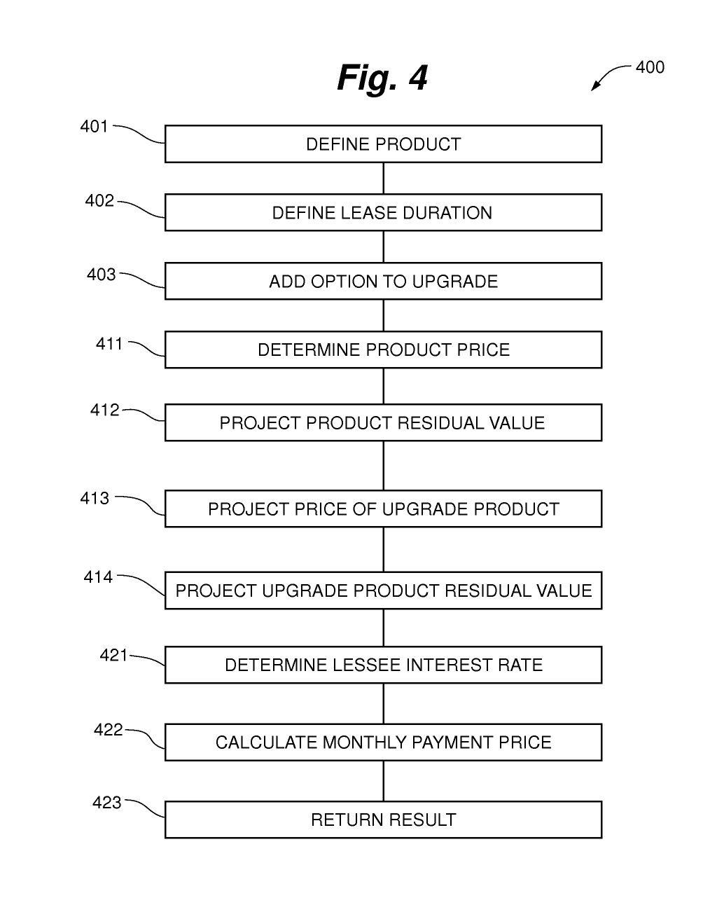

In step 304, the lessor calculates a lease price to charge the lessee and stores this information into the lease database 230 such as in data field 237. The price calculation will be described further in relation to FIG. 4. After the lease agreement details have been finalized, in step 305 the lease agreement between the lessor and lessee is executed, which creates a legally binding agreement between the lessor and lessee. The lessor transfers possession of the product or products to the lessee in step 306. The transfer of possession generally happens on the lease start date.

At some time on or after upgrade initiation date 245, the lessee may request to upgrade the original leased product to a newer version of the leased product. In step 310 of the method 300 the computerized system 201 receives an upgrade request through the user interface 112. The upgrade request identifies the lease information record 231 and the leased product 233 for which an upgrade is desired. The lease information record may be identified by a lease identifier, which may be a unique identifier assigned to the lease agreement for which the upgrade is requested. The lease identifier could alternately be lessee information such as lessee name, address, social security number, driver's license number, credit card number, or other identifier that identifies a lease information record 231 associated with a lessee. The computerized system 201 performs one or more database queries to determine whether to upgrade the leased product. The computerized system 201 may access databases 220, 230, 240, and 250 of FIG. 2. In step 311 computerized system 201 performs a database query to determine whether an upgrade product exists for the specified leased product. If an upgrade product does not exist, the computerized system 201 will so indicate through the user interface 112. In this case, the lessee will not receive an upgrade product. At the lessee's option, the lessee may make another upgrade request at a later date, or may choose not to request an upgrade again before the lease ends.

In an alternate embodiment, the upgrade request step 310 could include a request for a specific upgrade product. In this case, the computerized system 201 would perform a query in step 311 to determine whether the requested upgrade product is a product that is eligible to be an upgrade product to the original leased product. Specifically, the upgrade product should be in the same product category as the original leased product. In the exemplary embodiment shown in FIG. 2, Smartphone 221 is an eligible upgrade product for Smartphone 211, but Smartphone 221 is not an eligible upgrade product for Notebook 212 because it is in a different product category. The computerized system 201 would accept a request at to upgrade from Smartphone 211 to Smartphone 221, but would deny a request to upgrade from Notebook 212 to Smartphone 221.

If an upgrade product is found to exist in step 311, the computerized system 201 performs a database query in step 312 to determine whether the specified leased product is eligible for an upgrade. In the exemplary embodiment of FIG. 2, the computerized system 201 queries the upgrade eligibility data field 238 to make the determination at step 312. If the product is not eligible for an upgrade, the computerized system 201 will so indicate through the user interface 112. In this case, the lessee will not be given an upgrade product and will continue to use the leased product until the end of the lease term. The result of the query in step 312 will be negative in two cases. If the lessee did not choose the upgradeable product lease option at step 302, the product will not be eligible for upgrade. In addition, if the lease allows only one upgrade and the original product has already been upgraded, the product will not be eligible for upgrade again. In embodiments in which multiple upgrades of a single leased product are allowed, the product will not be eligible for upgrade if all of the upgrades have already been made by the lessee.

If the leased product is found eligible for upgrade in step 312, the computerized system 201 will perform a further database query in step 313 to determine whether the request is within the time period during which an upgrade is allowed. In one embodiment, the upgrade request 310 will not occur before the upgrade initiation date 245, which may be 90 days after the lease start date, and the upgrade request 310 must be made no later than the upgrade deadline date 243, which may be 90 days before the lease end date. The upgrade request may only be granted if the request date is between upgrade initiation date 245 and upgrade deadline date 243 (which includes falling exactly on the upgrade initiation date 245 or upgrade deadline date 243). If upgrade request 310 occurs before the upgrade initiation date 245, the lessee will be able to make a request again at a later date. If upgrade request 310 occurs after the upgrade deadline date 243, the computerized system 201 will deny the request and the lessee may continue to use the original leased product until the lease end date 236.

The queries 311, 312, 313 may occur in any order. If queries 311, 312, and 313 all return positive results, the computerized system 201 will grant the upgrade request, and an authorization for upgrade will be presented through the user interface 112. The lessor will receive a return of the leased product in step 321. The computerized system 201 will require that the lessee's lease information record 231 be updated in step 322 to indicate that the lessee has returned the original product. Because the original leased product still retains value after it is returned, the lessor may choose in step 341 to refurbish the product and in step 342 to offer the product for sale or lease as a refurbished, used product. Assuming that only a single upgrade is authorized under the lease, at step 323 the computerized system 201 will modify upgrade eligibility field 238 in the lease record 231 of FIG. 2 to indicate that the lessee is no longer eligible for a product upgrade, as the upgrade request in step 310 has already been granted. In step 324 the lessor transfers possession of the upgrade product (i.e., the newer version of the original leased product) to the lessee. In step 325 the computerized system 201 updates the lease record 231 to indicate that the lessee possesses the upgrade product.

After the product upgrade, the lease ends at step 331 when the computerized system 201 identifies that the current date is after the lease end date 236 in the lease record 231. There are two options for the lessee when the lease ends. The lessee may purchase the leased product in step 335. The lessee may also return the product to the lessor, with the lessor receiving the product in 332. The leased product will be the upgrade product if the lessee successfully upgraded the product at steps 310-325, or else the originally leased product if no upgrade took place. At the lessor's option, the lessor may choose to refurbish the returned product at step 333 and offer the product for sale in step 334.

FIG. 4 presents a method 400 that allows a computer to use an algorithm to calculate the lease price to charge a lessee in a lease agreement. The lease may be a lease according to FIG. 1-3 as previously discussed. In step 401 the computer receives input identifying a product to lease. This step may also include receiving input relating to a service, or relating to more than one product to lease in a single lease agreement. In step 402 the computer receives input identifying a lease duration. In step 403 the computer receives input selecting to add the option to upgrade the leased product to a newer version of the leased product in an upgradeable product lease agreement. The price calculation is performed by determining the original price of the product in step 411, projecting the residual value of the product at some time during the lease term in step 412, projecting the price of the upgrade product at step 413, and projecting the residual value of the upgrade product at the lease end date in step 414.

Because the upgrade product is not specifically determined when the lease is executed, the lessor must take into consideration historical information to make the projections in steps 412, 413, and 414. The projections may take into consideration historical data, such as price data and product release data. Using historical data allows the computer system to estimate the date around which a newer version of a product is expected to be released, allowing the lessor to estimate the age of the original leased product when the upgrade occurs. However, the fact that the lessee may upgrade to a newer product at a time of the lessee's choosing presents a level of uncertainty in the calculation. Another degree of uncertainty arises because the newer version might increase in price over the original product because of the general overall increase in electronics prices, but the newer product could instead decrease in price because certain products become less expensive as technology evolves. So-called “early adopters” may pay a premium price for a new, first-generation product, but a second, later version of the product may become less expensive as the technology becomes more widely available. An example of this phenomenon is the decreasing price over time for televisions with a similar feature set. The price of an upgrade product may also remain the same as the original product.

In step 414, projecting the expected residual value of the upgrade product on the lease end date 236 may take into account the estimated release date of a newer version of the leased product, and the likely age of the upgrade product on the lease end date 236. Obviously, the time of the upgrade affects the future residual value, but the effects are counter-balanced. An early upgrade will mean that the upgraded product will be older at the end of the product lease, and therefore have a smaller residual value. However, the early upgrade will also indicate that the originally leased item will be newer at the time of the upgrade, and therefore will have a larger residual value. The use of an upgrade deadline date 243 and an upgrade initiation date 245 helps prevent extremes in the upgrade date, and simplifies the lease price calculation.

In step 421, an imputed rate is determined for the lessee. The lease payment calculation in step 422 is performed at a computer, and uses the variables identified in steps 401-421 to determine a lease payment for the lease. In step 423 the computer returns the results of the calculation and stores the results in the lease price data field 237 in lease database 230 of FIG. 2.

FIG. 5 presents a method 500 for leasing two or more products in a single lease agreement. In step 501, the lease terms and conditions are determined. As in FIG. 3, lease terms may include gathering lessee information, choosing a lease term, choosing a lease duration, and defining other details necessary for entering a lease agreement. In method 500, two distinct products are chosen: a first product in step 502 and a second product in step 503. In step 504 the price of the first product and the price of the second product are assessed along with the projected residual value of both the first and second products. In step 505 the price and residual value for the first and second upgrade products are assessed. As detailed in relation to FIG. 4, many variables exist when making the determinations in step 505. The projection may take into account an estimated release date for the first upgrade product, an estimated release date for the second upgrade product, the initial price for the first upgrade product and the second upgrade product, and the expected depreciation of the first and second upgrade products. Based on the variables in steps 501-505, a periodic lease payment is calculated in step 506. The calculating step 506 may incorporate the method 400 of FIG. 4. As part of the lease agreement, the periodic lease rate does not change throughout the duration of the lease term, even when the first product and second product are upgraded to newer versions of the first and second products. The lease agreement is executed in step 510, which creates a legally binding agreement between the lessor and lessee. Both the first and second products are transferred to the lessee in step 511. At some point on or after the upgrade initiation date 245 the lessee may, at the lessee's choosing, request to upgrade the first product to a newer version of the first product in step 520. In step 521, the computerized system 201 performs a database query to determine whether the first product is eligible to be upgraded. Although not explicitly shown in FIG. 5, step 521 will be similar to steps 311, 312, and 313 of FIG. 3: the computerized system 201 queries a database or databases to determine whether a first upgrade product exists, whether the first product is eligible for upgrade, and whether the request is made on or after the upgrade initiation date 245 and on or before the upgrade deadline date 243. If in step 521 the product is not found to be eligible for upgrade, the lessee may either wait to make another request at a later time, or may choose to not make another request and keep the original product until the lease ends.

If the first product is eligible for upgrade, the lessor receives a return of the first product and transfers possession of a first upgrade product to the lessee in step 522. Step 522 also encompasses steps 322, 323, and 325 from FIG. 3, in which computerized system 201 modifies a lease record 231 to indicate that the lessee has returned the first product, updates the lease record 231 to indicate that the first product is no longer eligible for upgrade, and updates the lease record 231 to indicate that the lessee has received the first upgrade product. Step 522 may also encompass steps 341 and 342, in which the lessor refurbishes the returned product and offers the product for sale.

In step 530, a request is made to upgrade the second product to a second upgrade product. Step 530 may happen before, after, or at the same time as the first product upgrade request in step 520. At step 531 the computerized system 201 performs database queries to determine whether the second product is eligible to upgrade. As with step 521, step 531 encompasses a computerized system 201 querying a database to determine whether a second upgrade product exists, querying a database to determine whether the second product is eligible for upgrade, and querying a database to determine whether the request is made on or after the upgrade initiation date 245, and on or before the upgrade deadline date 243. If the second product is not eligible to be upgraded, the lessee may wait and request an upgrade of the second product at a later time, or may choose to not make another request and keep the second product until the lease ends.

If the second product is eligible for upgrade, the lessor receives a return of the second product and transfers possession of the second upgrade product to the lessee in step 532, similar to step 522. This step also encompasses the computer system updating a lease record 231 in a lease database 230 to indicate that the lessee has returned the second product, upgrading the lease record 231 to indicate that the second product is no longer eligible for upgrade, and updating the lease record 231 to indicate that the lessee has received the second upgrade product.

The lease ends at step 540, when the computerized system 201 identifies that the current date is after the lease end date 236 in the lease record 231. The lessee has the option to purchase the first and second products at step 542. The lessee may also purchase one of the first and second products at step 543 while returning another of the first and second products at step 544. The lessee may choose to return both the first and second products at step 541. After steps 541, 544, 522, and 532 the lessor may refurbish the returned products and offer the refurbished products for sale.

FIG. 6 shows steps in a method for adding a service to a lease agreement. Method 600 is presented independently for clarity, but the method 600 may be combined with the methods shown in FIGS. 3, 4, and 5 to create a single lease having one or more products and one or more services associated with the products. At step 601, the lease terms and conditions are defined. Lease terms and conditions may include lessee information, the product or products to lease, lease term, lease duration, lease start date, and lease end date. At step 602 one or more services are added to the terms of the lease. Services may include cable television service, Internet service, multimedia services, a mobile phone plan, a mobile data plan, installation services, warranty, or other product-related services. In step 603 the lessee accepts the option to upgrade the one or more leased products to newer versions of the one or more leased products in an upgradable product lease. The upgradable product lease includes the provision that the chosen service or services will continue or be upgraded as necessary, and the service or services will be provided during the entirety of the lease term.

At step 604 of method 600, an assessment is made of the projected cost to continue the service or services when the product or products are upgraded. Costs associated with upgrading a product to a newer version of the product may include additional activation fees, data transfer fees, installation fees, home network setup fees, or other costs. Factors that must be considered include whether the service-related costs will be expected to increase or decrease during the lease term. For example, if a mobile phone with 3G compatibility is upgraded to a newer version of the phone, and the newer version is compatible with a 4G network, a mobile data plan for the upgrade phone may become more expensive. Conversely, the mobile data plan may become less expensive as the technology becomes more widely available. Because the periodic lease rate does not change throughout the duration of the lease term, these factors must be taken into consideration when the periodic lease rate is calculated in step 605. The calculation step 605 may incorporate the calculation method 400 of FIG. 4, and also encompasses performing the calculation, returning the results of the calculation, and storing the results in a database.

In step 610 the lease agreement is executed which creates a legally binding agreement between the lessor and lessee, and possession of the product or products are transferred to the lessee in step 611. In step 612 the service or services are provided to the lessee as appropriate. The services could include physically installing a television or home theater, providing a cable television or Internet service, setting up a home wireless network, and providing a mobile phone or mobile data plan. Ongoing services such as extended warranty, maintenance, or technical service would also be performed as necessary in step 612. At step 620 the lessee initiates a request to upgrade the product or products to a newer version of the product or products, as detailed in FIG. 3 and FIG. 5. After the one or more products are upgraded in step 621, services are provided in step 622. The services may include ongoing services such as mobile phone or mobile data plans, cable television or Internet services, and other such services that may remain unchanged during the lease term. One-time services may also be provided in step 622, such as data transfer from a leased computer to an upgrade computer, or removal of an original television and installation of an upgraded television into a home. If products are upgraded to upgrade products at different times, the services in step 622 would be provided at times appropriate for each product.

The lease ends at step 630 when the computerized system 201 identifies that the current date is after the lease end date 236 in the lease record 231. The lessee may choose at step 633 to purchase the one or more leased products. The price that the lessee pays to purchase the one or more products at step 633 may include further payment for any services that will continue to be provided after the purchase. If the lessee decides not to purchase the products, the lessor receives a return of the one or more products at step 631, and discontinues the services to the lessee at step 632.

The many features and advantages of the invention are apparent from the above description. Numerous modifications and variations will readily occur to those skilled in the art. For example, the system and methods may be extended to products and services in categories other than electronics products and services. The lessee could also be allowed to upgrade an original leased product more than once during the lease term. Since such modifications are possible, the invention is not to be limited to the exact construction and operation illustrated and described. Rather, the present invention should be limited only by the following claims.

1. A computer-implemented method for administering a lease agreement, the method comprising:
a) creating a data record regarding a lease between a lessor and a lessee, in a tangible, non-transitory memory of a computer, the computer having a processor operably connected to the memory, the data record containing data fields specifying
i) a lease identifier,
ii) a lessee,
iii) a first leased product having a product price,
iv) a lease term having a lease start date and a lease end date, and
v) an upgrade eligibility status indicating that the lessee is eligible to upgrade the first leased product;
b) projecting, by the computer,
i) a first residual value, for the first leased product upon its return to the lessor pursuant to the lease,
ii) a price for an upgrade product, and
iii) a second residual value, for the upgrade product upon its return to the lessor pursuant to the lease;
c) calculating, by the computer, a lease rate based on
i) the first leased product price,
ii) the projected first leased product projected residual value,
iii) the lease term,
iv) the upgrade eligibility status,
v) the upgrade product projected price, and
vi) the projected second residual value; and
d) storing the lease rate as a data field in the data record in the memory.

2. The method of claim 1, wherein the data record further comprises a data field specifying a service associated with the first leased product, and step c) further comprises calculating the lease rate based on the service.

3. The method of claim 1, further comprising:
e) receiving, from a user interface, a request to upgrade the first leased product, the request specifying the lease identifier and a requested upgrade product;
f) identifying the data record based on the lease identifier;
g) querying the data record to determine the upgrade eligibility status in the data record;
h) querying the data record to determine that the requested upgrade product is an eligible upgrade product for the first leased product; and
i) creating, in the data record, a data field specifying that the requested upgrade product is leased in the lease agreement.

4. The method of claim 3, further comprising:
j) setting the upgrade eligibility status field to indicate that the first leased product is not eligible to upgrade after step i).

5. The method of claim 3, wherein the lease rate does not change during the lease term.

6. The method of claim 1, wherein the first leased product is in a product category selected from the group consisting of a mobile phone, a personal computer, a notebook computer, a tablet computer, a television, a digital camera, a gaming console, and a multimedia player.

7. The method of claim 6, wherein the leased upgrade product is in the same product category as the first leased product.

8. A processor-implemented leasing method comprising:
a) on a computer having a processor and a tangible, non-transitory memory, defining a lease record in a database stored on the memory, the lease record containing an original leased product, a lease term having a lease start date and a lease end date, a lease price, and an upgrade eligibility, the upgrade eligibility specifying that the original leased product is eligible to be upgraded to an upgrade product;
b) transferring the original leased product to a lessee;
c) receiving a request to upgrade the original leased product to an upgrade leased product on an upgrade request date;
d) performing a database query at the computer, in response to the upgrade request, to determine whether the original leased product is eligible to be upgraded;
e) confirming, by the computer in response to the database query, that the original leased product is eligible to be upgraded;
f) receiving a return of the original leased product from the lessee;
g) transferring the upgrade leased product to the lessee during the lease term; and
h) receiving a return of the upgrade leased product from the lessee;
wherein the upgrade leased product is a new model similar to the original leased product and the lease price does not change during the lease term, and wherein the lease price depends upon a projected change in value of the original leased product between its transfer to the lessee and its return and upon a projected change in value of the upgrade leased product between its transfer to the lessee and its return.

9. The method of claim 8, wherein the lease record in the database further contains an upgrade initiation date and an upgrade deadline date, and the database query includes determining whether the upgrade request date is between the upgrade initiation date and the upgrade deadline date.

10. The method of claim 9, wherein the upgrade initiation date is after the lease start date and before the upgrade deadline date.

11. The method of claim 9, wherein the upgrade deadline date is after the upgrade initiation date and before the lease end date.

12. The method of claim 8, wherein the lease record further includes a service associated with the original leased product, the method further comprising:
i) providing the service during the lease term.

13. The method of claim 8, wherein the computer calculates the lease price based on the price of the original leased product, the lease term, and a projected cost of providing the upgrade leased product to the lessee.

14. The method of claim 8, wherein the original leased product is in a product category selected from the group consisting of a mobile phone, a personal computer, a notebook computer, a tablet computer, a television, a digital camera, a gaming console, and a multimedia player.

15. The method of claim 14, wherein the upgrade leased product is in the same product category as the original leased product.

16. A computer-implemented leasing system, comprising:
a) a computer having a tangible, non-transitory memory, computer programming residing on the memory, and a computer processor;
b) a product database residing on a tangible, non-transitory product database memory and accessible by the computer, the product database containing original product records, the original product records representing original products available to lease;
c) a lease database residing on a tangible, non-transitory lease database memory and accessible by the computer, the lease database containing lease information records for a plurality of executed leases, each lease information record including lessee information, original leased product information associated with an original product, lease term information having a lease start date and a lease end date, and upgrade eligibility status information;
d) an upgrade database residing on a tangible, non-transitory upgrade database memory and accessible by the computer, the upgrade database containing upgrade product records, the upgrade product records representing available upgrade products linked to original products, each upgrade product being a newer version of an original product in the product database;
wherein the upgrade eligibility status information indicates that the lessee is eligible to upgrade the original leased product to a newer version of the original leased product after the lease start date and before the lease end date.

17. The system of claim 16, wherein the computer programming comprises computer instructions configured to:
i) receive a request at the computer to upgrade an original leased product in an executed lease;
ii) query a lease information record in the lease database to determine the upgrade eligibility status in the executed lease;
iii) query the upgrade database to determine that an upgrade product record linked to the original leased product exists;
iv) confirm, in response to the database query, that the original leased product is eligible to be upgraded; and
v) modify the lease information record to include upgrade product information indicating that the original leased product has been upgraded to the upgrade product.

18. The system of claim 16, further comprising:
a services database residing on a tangible, non-transitory services database memory and accessible by the computer, the services database containing service records, the service records representing available services associated with leased products;
wherein the lease information records further include services information linked to a service record and describing services provided under the executed leases.

19. The system of claim 16, wherein the original products and upgrade products are in at least one product category selected from the group consisting of mobile phones, personal computers, notebook computers, tablet computers, televisions, digital cameras, gaming consoles, and multimedia players.

20. The system of claim 16, wherein the product database and the upgrade database are maintained within the same database structure.

21. A method for leasing a product, comprising:
a) selecting a first product to lease in a lease agreement between a lessor and a lessee;
b) selecting a lease term including a lease start date, a lease end date, and a lease duration, and saving this information in tangible storage;
c) assigning, in the lease, an option for the lessee to upgrade the first product to an upgrade product;
d) calculating by a computer a fixed periodic lease rate based upon the price of the first product, the lease duration, and the option to upgrade, wherein data regarding the price, the duration, and the option are obtained by the computer from tangible storage;
e) executing the lease agreement;
f) transferring the first product to the lessee;
g) receiving a request by the lessor, at a time chosen by the lessee within time constraints specified in the lease agreement, to exercise the option and to upgrade the first product to an upgrade product;
i) receiving a return of the first product from the lessee; and
j) transferring the upgrade product to the lessee.

22. The method of claim 21, wherein the periodic lease rate does not change between the lease start date and the lease end date.

23. The method of claim 22, further comprising:
k) defining in the lease an upgrade initiation date that is after the lease start date; and
l) defining in the lease an upgrade deadline date that is after the upgrade initiation date and before the lease end date;
wherein step h) includes querying the database to determine whether the upgrade request date is between the upgrade initiation date and the upgrade deadline date.

24. The method of claim 23, further comprising:
m) selecting a second product to lease in the lease agreement;
n) assigning, in the lease, an option for the lessee to upgrade the second product to a second upgrade product;
o) further calculating the periodic lease rate in step d) based on the price of the second product;
p) transferring the second product to the lessee;
q) receiving a request to upgrade the second product on a second upgrade request date that is between the upgrade initiation date and the upgrade deadline date;
r) querying a computer database to determine whether the lease provides the option to upgrade the second product;
s) receiving a return of the second product; and
t) transferring the second upgrade product to the lessee.

25. The method of claim 24, wherein step g) occurs on a different date than step q).

26. The method of claim 21, wherein the first product is in a product category selected from the group consisting of a mobile phone, a personal computer, a notebook computer, a tablet computer, a television, a digital camera, a gaming console, and a multimedia player.

27. The method of claim 24, wherein the first product is in a first product category and the second product is in a second product category different from the first product category.

28. The method of claim 21, further comprising:
k) offering the first product for sale as a used product after step i).

29. A method, comprising:
a) maintaining in tangible digital storage a database having entries that map products to respective corresponding upgrade products;
